(19) United States
(12) Patent Application Publication
(10) Pub. No.: US 2020/0399107 A1
(43) Pub. Date: Dec. 24, 2020

(54) SPRING SYSTEMS FOR LIFTING AERIAL WORK PLATFORMS

(71) Applicant: Oshkosh Corporation, Oshkosh, WI (US)

(72) Inventors: Wallace C. Buege, West Bend, WI (US); Andrew J. Kotloski, Green Lake, WI (US); Martin J. Schimke, Red Granite, WI (US); Eric E. Braun, Neenah, WI (US)

(73) Assignee: Oshkosh Corporation, Oshkosh, WI (US)

(21) Appl. No.: 16/905,492

(22) Filed: Jun. 18, 2020

Related U.S. Application Data
(60) Provisional application No. 62/863,614, filed on Jun. 19, 2019.

(51) Int. Cl. B66F 11/04; B66F 7/06; B66F 7/28; B66F 7/08

(52) U.S. Cl. CPC B66F 11/042; B66F 7/08; B66F 7/28; B66F 7/0666

(57) ABSTRACT

An aerial work platform (AWP) includes a base, a retractable lifting mechanism, a platform, an actuator, and a spring. The retractable lifting mechanism has a first end rotatably coupled to the base. The platform is coupled to and supported by a second end of the retractable lifting mechanism. The actuator is pivotally coupled to the retractable lifting mechanism. The actuator has a piston received within a housing that is movable between a stowed position and a deployed position, where the piston engages and forces the retractable lifting mechanism away from the base to lift the platform away from the base. The spring biases the retractable lifting mechanism away from the base and provides a variable biasing force to the retractable lifting mechanism that increases as the piston approaches the stowed position.

### CROSS-REFERENCE TO RELATED APPLICATION

This application claims priority to U.S. Provisional Patent Application No. 62/863,614, filed Jun. 19, 2019, the content of which is hereby incorporated by reference in its entirety.

### BACKGROUND

Scissor lifts and other aerial work platforms (AWPs) are used to position a worker at different vertical positions to perform tasks. AWPs typically use hydraulic cylinders to move a platform of the AWP and a worker on the platform vertically relative to a base of the AWP. When the hydraulic cylinder is extended, the hydraulic cylinder pushes a retractable assembly apart, simultaneously raising the retractable assembly away from the base of the AWP and raising the platform away from the base. The hydraulic cylinder can move between fully stowed and fully extended positions, which allows a height of the platform to be adjusted to several vertical positions relative to the base. The platform lifts and supports workers at a range of different heights to accomplish tasks.

### SUMMARY

One exemplary embodiment relates to an aerial work platform (AWP). The AWP includes a base, a retractable lifting mechanism, a platform, an actuator, and a spring. The retractable lifting mechanism has a first end rotatably coupled to the base. The platform is coupled to and supported by a second end of the retractable lifting mechanism. The actuator is pivotally coupled to the retractable lifting mechanism. The actuator has a piston received within a housing that is movable between a stowed position extending outward from the housing a first distance and a deployed position extending outward from the housing a second distance greater than the first distance. In the deployed position, the piston engages and forces the retractable lifting mechanism away from the base to lift the platform away from the base. The spring biases the retractable lifting mechanism away from the base and provides a variable biasing force to the retractable lifting mechanism that increases as the piston approaches the stowed position.

Another exemplary embodiment relates to a scissor lift. The scissor lift includes a base, a retractable lifting mechanism, a platform, an actuator, and a passive spring. The retractable lifting mechanism is formed of a plurality of foldable support members rotatably coupled to one another about pins. A lowermost group of the plurality of foldable support members are rotatably coupled to the base. The platform is coupled to and supported by an uppermost group of the plurality of foldable support members of the retractable lifting mechanism. The actuator is pivotally coupled to at least one of the plurality of foldable support members. The actuator has a piston movable between a stowed position and an extended, deployed position. The piston engages and forces the plurality of foldable support members away from the base to lift the platform away from the base in the deployed position. The passive spring biases the retractable lifting mechanism away from the base when the actuator is in the stowed position more than when the actuator is in the deployed position.

Another exemplary embodiment relates to a scissor mechanism. The scissor mechanism includes a base, a plurality of foldable support members, a platform, an actuator, and a spring. The plurality of foldable support members are rotatably coupled to one another about pins. A lowermost group of the plurality of foldable support members are rotatably coupled to the base. The platform is coupled to and supported by an uppermost group of the plurality of foldable support members. The actuator is pivotally coupled to at least one of the plurality of foldable support members. The actuator has a piston movable between a stowed position and an extended, deployed position. The piston engages and forces the plurality of foldable support members away from the base to lift the platform away from the base in the deployed position. The spring is independent from the actuator and provides a biasing force on the plurality of foldable support members to push the plurality of foldable support members away from the base. The biasing force reaches a maximum when the actuator is in the stowed position and reduces to zero before the actuator reaches the deployed position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of an AWP in a stowed position, according to an exemplary embodiment;

FIG. 2 is a perspective view of the AWP of FIG. 1 in a deployed position;

FIG. 3 is a cross-sectional view of the AWP of FIG. 1 taken along the section line N-N, depicting a secondary lifting system;

FIG. 4 is a cross-sectional view of the AWP of FIG. 1 taken along the section line N-N, modified with a secondary lifting system according to another exemplary embodiment;

FIG. 5 is a cross-sectional view of the AWP of FIG. 1 taken along the section line N-N, modified with a secondary lifting system according to still another exemplary embodiment; and

FIG. 6 is a perspective view of an AWP in a partially-deployed position, according to another exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the FIGURES generally, the various exemplary embodiments disclosed herein relate to systems, apparatuses, and methods for operating an AWP or mobile elevated work platform (MEWP), such as a scissor lift or boom lift. The AWP includes a base and a retractable lifting mechanism supporting a height-adjustable platform. The retractable lifting mechanism and platform are movable between a stowed position and a deployed position using an actuator, such as a hydraulic cylinder or electric linear actuator. The AWP incorporates a secondary lifting system in the form of one or more springs (e.g., biasing and/or spring elements) that are configured to provide an auxiliary lifting force to help push the retractable lifting mechanism and platform away from the base.

The secondary lifting system stores energy when the AWP is in the stowed position that can be used to lift the retractable lifting mechanism and platform away from the base. The secondary lifting system opposes the platform and retractable lifting mechanism from transitioning to or resting in the fully stowed position, but does not produce a force sufficient to offset a combined gravitational force acting on the platform and retractable lifting mechanism and/or a retraction force of the actuator. Accordingly, the combined gravitational force (and/or retraction force) causes the secondary lifting system to flex and store potential energy when the platform reaches the fully stowed position. The secondary lifting system releases the stored potential energy to help raise the platform and retractable lifting mechanism by resiliently returning to its resting orientation, which happens in the beginning stages of the deployment process.

The secondary lifting system and actuator then work together during the initial stages of the deployment process, when the mechanical advantage of the actuator relative to the retractable lifting mechanism is at its lowest. The secondary lifting system then reduces the total amount of force the actuator must produce in order to deploy and raise the retractable lifting mechanism and platform away from the base. The secondary lifting system reduces the peak forces typically experienced early in the deployment of the actuator, which creates a more uniform loading distribution throughout the platform raising and lowering processes. The more uniform loading distribution and lower peak forces can reduce wear and maintenance needs for the AWP or MEWP. By reducing the total force requirements for the actuator, smaller, more efficient actuators can be used, which can also reduce the cost of manufacturing AWPs and MEWPs.

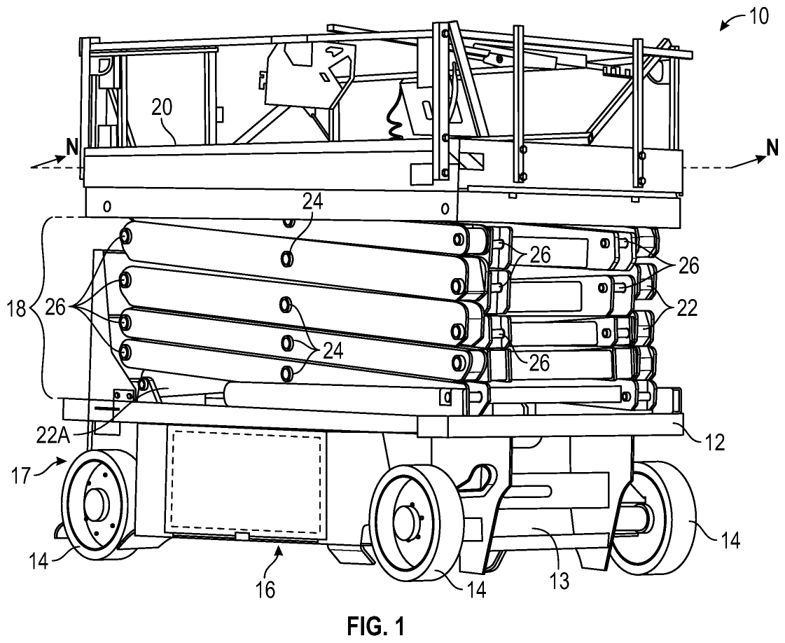

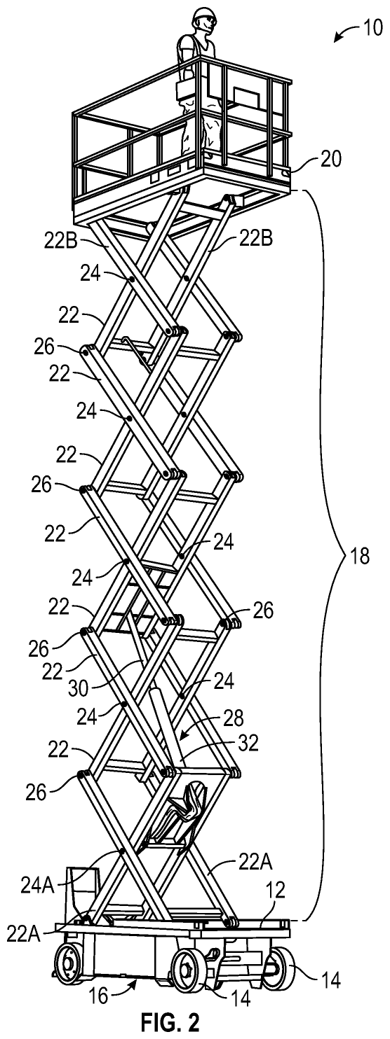

Referring to FIGS. 1 and 2, an AWP 10 is shown. The AWP 10 can be a scissor lift or a boom lift, for example, which can be used to perform a variety of different tasks at various heights relative to the ground below. The AWP 10 includes a base 12 supported by a chassis 13. Wheels 14 are coupled to the chassis 13 and positioned about the base 12. The wheels 14 can be driven by a prime mover 16 (e.g., an engine, an electric motor, etc.) that generates torque and rotational motion to propel the AWP 10 to a desired location for completing a task. The wheels 14 can include a steering system 17 to position two or more of the wheels 14 to help direct and position the AWP 10 within a desired location. Various exemplary steering systems that can be incorporated into the AWP 10 are shown and described in commonly-owned PCT/US2020/021341, entitled “Lift Steering Systems and Methods,” the content of which is hereby incorporated by reference in its entirety.

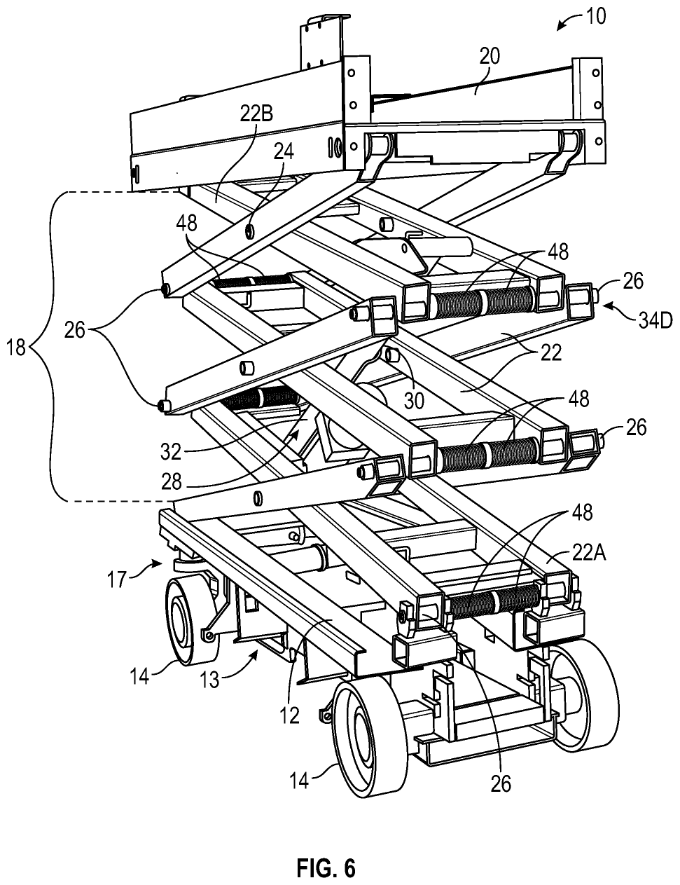

A retractable lifting mechanism 18 is coupled to the base 12 and supports a work platform 20. As shown in FIGS. 1-6, the retractable lifting mechanism 18 is a scissor lift structure formed of a series of linked, foldable support members 22 connected to one another using central pivot pins 24 and outer pivot pins 26. The central pivot pins 24 and outer pivot pins 26 extend through adjacent support members 22 to pivotally couple the support members 22 in an assembly. The support members 22 include lowermost foldable support members 22A pivotally coupled to the base 12 and uppermost foldable support members 22B pivotally coupled to an underside of the platform 20. Adjusting the angular relationships between adjacent support members 22, 22A, 22B pivots the lowermost foldable support members 22A and other support members 22, 22B away from the base and away from one another, and alters the position of the platform 20 relative to the base 12 so that tasks can be accomplished at different heights. As the relative angle between the support members 22 and the base 12 increases, the height of the platform 20 increases until a maximum value is reached.

The retractable lifting mechanism 18 is selectively movable between a retracted, or “stowed” position (shown in FIG. 1) and a deployed, or “work” position (shown in FIG. 2) using an actuator 28. The actuator 28 can be a hydraulic cylinder, a pneumatic cylinder, or an electric linear actuator, for example. The actuator 28 controls the position of the retractable lifting mechanism 18 and platform 20 by selectively and/or variably applying force into the support members 22 of the lifting mechanism 18 to adjust the relative angles between adjacent support members 22, which rotate about the pivot pins 24, 26.

As demonstrated in FIGS. 1-2, the amount and type of force applied to the retractable lifting mechanism 18 by the actuator 28 can be controlled by changing an overall length of the actuator 28. The actuator 28 is pivotably mounted to one or more of the support members 22 and includes a piston 30 that is movably received in the housing 32. The piston 30 can slide or otherwise translate into or out of the housing 32, which adjusts the overall length of the actuator 28. Because the actuator 28 is mounted either between the base 12 and a support member 22 or between two different support members 22, moving the piston 30 relative to the housing 32 changes the distance between at least one of the support members 22 and the base 12, and causes the adjacent support members 22 to rotate about the pivot pins 24, 26. Rotation of the support members 22 relative to one another and relative to the base 12 is transmitted to each of the other support members 22 within the retractable lifting mechanism 18, and raises or lowers the platform 20 accordingly. If the piston 30 retracts into the housing 32, the length of the actuator 28 decreases, and pulls the support members 22 within the retractable lifting mechanism 18 together, which lowers the platform 20 toward the base 12. If the piston 30 advances out of the housing 32, the length of the actuator 28 increases, and pushes the support members 22 within the retractable lifting mechanism 18 apart, raising the platform 20 away from the base. Accordingly, the length of the actuator 28 determines the magnitude and direction of the force applied to the lifting mechanism 18, which in turn determines the position of the retractable lifting mechanism 18 and platform 20.

In the fully-stowed position shown in FIG. 1, the piston 30 is received within the housing 32 and minimal, if any upward vertical force is exerted from the piston 30 onto the retractable lifting mechanism 18. In some examples, when the piston 30 is fully retracted into the housing 32, the piston 30 pulls the support members 22 of the retractable lifting mechanism 18 together and downward, toward the base 12. To transition the retractable lifting mechanism 18 and the platform 20 out of the stowed position, the piston 30 is advanced outward from the housing 32 of the actuator 28, in an at least partially upward vertical direction to push the support members of the retractable lifting mechanism 18 apart. When a sufficient force is supplied by the piston 30 to the lifting mechanism 18 (e.g., through one of the support members 22), the lifting mechanism 18 unfolds or otherwise deploys from the stowed, rest position, and raises away from the base 12. The piston 30 can be advanced outward from the housing 32 to a maximum extended position, which in turn fully deploys the lifting mechanism 18, as depicted in FIG. 2. Because the work platform 20 is coupled to the lifting mechanism 18, the work platform 20 is also raised away from the base 12 in response to the deployment of the lifting mechanism 18.

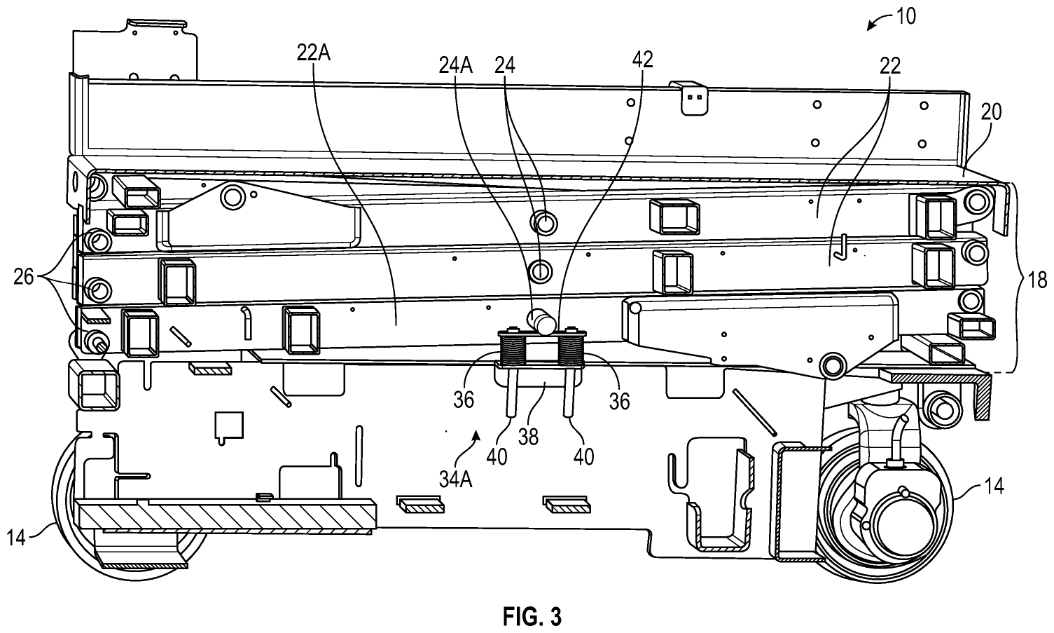

With additional reference to FIGS. 3-6, the AWP 10 includes a secondary lifting system 34A, 34B, 34C, 34D. The secondary lifting system 34A, 34B, 34C, 34D is made of one or more springs and/or biasing elements that can passively store and release energy to aid the actuator 28 in lifting the retractable lifting mechanism 18 and platform 20 away from the base 12, particularly during the initial stages of the deployment process. The secondary lifting system 34A, 34B, 34C, 34D applies a biasing force onto the retractable lifting mechanism 18 that can combine with the actuator 28 to push the retractable lifting mechanism 18 and platform 20 away from the base 12 during a portion of the deployment process. For example, the secondary lifting system 34A, 34B, 34C, 34D may supply biasing force to aid in lifting and deploying the retractable lifting mechanism 18 over only the initial 10 percent of the deployment process (e.g., when the piston transitions from fully stowed to 10 percent of its fully extended position) to help offset normally high force requirements on the actuator 28 when the mechanical advantage between the actuator 28 and the retractable lifting mechanism 18 is at a minimum. In other examples, the secondary lifting system is configured to supply biasing force to aid in lifting and deploying the retractable lifting mechanism 18 over a more significant portion of the deployment process (e.g., between 20 percent and 100 percent). In some examples, the secondary lifting system 34A, 34B, 34C, 34D operates independent of the actuator 28. The secondary lifting system 34A, 34B, 34C, 34D can be mounted directly to the base 12, positioned between adjacent foldable support members 22, received around one or more central pivot pins 24 or outer pivot pins 26, received around or positioned in series with the actuator 28, or positioned in other suitable locations to interact with and bias the foldable support members 22 within the retractable lifting mechanism 18 away from the fully-stowed position.

In some embodiments and as depicted in FIG. 3, the secondary lifting system 34A includes a series of compression springs 36. The compression springs 36 can be coupled to and supported by a stand 38 that is mounted to the base 12 of the AWP 10. Legs 40 can extend away from a bottom of the stand 38 into holes formed in the base 12 to anchor the stand 38 in a constant position relative to the base 12. The stand 38 can be approximately centered within the base 12, which allows the compression springs 36 to act on several foldable support members 22 simultaneously.

The compression springs 36 can be spaced apart from one another about the stand 38 to provide a vertical force to the lowermost foldable support members 22A within the retractable lifting mechanism 18. The compression springs 36 extend approximately perpendicularly (e.g., within about 10 degrees) to a plane defined by the base 12, and can be positioned in a parallel array to supply force at multiple locations along the lowermost foldable support members 22A. For example, four compression springs 36 can be positioned equidistantly apart from one another on the stand 38. The compression springs 36 can support a bearing plate 42 that can distribute loading to and from the compression springs 36 evenly. In some examples, the bearing plate 42 interfaces with the lowermost central pivot pin 24A that connects the lowermost foldable support members 22A. The gravitational forces acting on the retractable lifting mechanism 18 and the platform 20 can then be transferred through the lowermost central pivot pin 24A to the bearing plate 42, which in turn causes the compression springs 36 to compress downward evenly, storing energy.

The compression springs 36 are configured to resist and oppose the retractable lifting mechanism 18 and platform 20 from reaching the fully-stowed position on the base 12 of the AWP 10. However, the compression springs 36 are provided with a spring constant that is not large enough to fully impede downward movement to the fully-stowed position, so the compression springs 36 flex and store energy as the retractable lifting mechanism 18 and platform 20 approach the fully-stowed position on the base 12. In the fully deployed position, the lowermost foldable support members 22A, and therefore the lowermost central pivot pin 24A are elevated away from the base 12. In the fully deployed position, the lowermost central pivot pin 24A can be disengaged from and spaced apart vertically from the bearing plate 42, which allows the compression springs 36 to relax and return to their collective resting positions. When the actuator 28 is transitioned away from the fully-deployed position, the platform 20 and retractable lifting mechanism 18 begin to fold downward and inward, and the lowermost central pivot pin 24A travels downward, until it engages the compression springs 36 and/or the bearing plate 42. The compression springs 36 resist further downward motion of the retractable lifting mechanism 18 and platform 20 as the piston 30 of the actuator 28 continues to retract into the housing 32, and compress as the retractable lifting mechanism 18 and platform 20 continue to travel toward the base 12. The biasing force produced by the compression springs 36 and acting against the retractable lifting mechanism 18 and platform 20 continues to rise as the platform 20 travels downward, and reaches a maximum when the platform 20 and retractable lifting mechanism 18 reach the fully-stowed position.

The compression springs 36 can be configured to provide a biasing force that is less than the combined gravitational force acting on the retractable lifting mechanism 18 and platform 20, so that the compression springs 36 oppose but do not prevent the retractable lifting mechanism 18 and platform 20 from reaching the fully-stowed position. The magnitude of the biasing force provided by the compression springs 36 can be less than 50 percent of the combined gravitational force acting on the retractable lifting mechanism 18 and platform 20, or less than about 20 percent of the combined gravitational force, for example. In some examples, the magnitude of the biasing force provided by the compression springs 36 is at, above, or near 100 percent of the combined gravitational force acting on the retractable lifting mechanism 18 and platform 20, and the pulling force provided by the fully-retracted actuator 28 is needed to overcome the biasing force of the springs 36 in order to reach the fully-stowed position. A resting length and spring constant of the compression springs 36 can be varied to achieve a biasing force acting against the combined gravitational force acting on the retractable lifting mechanism 18 and platform 20. In some examples, the secondary lifting system 34A can include springs having different spring constants or lengths and the positioning of the springs can be varied so that the springs aid the actuator 28 in the deployment process at different points during deployment.

The energy stored within the compression springs 36 can be transferred back to the retractable lifting mechanism 18 to lift the retractable lifting mechanism 18 and platform 20 away from the base 12. When the actuator 28 is activated and the piston 30 begins extending outward from the housing 32, the piston 30 initially has a poor mechanical advantage relative to the retractable lifting mechanism 18. The force required of the piston 30 to begin raising the retractable lifting mechanism 18 is at a maximum when the platform 20 and retractable lifting mechanism 18 are in the fully-stowed position. By storing energy within the compression springs 36, the secondary lifting system 34A reduces the force requirement on the actuator 28. Because the compression springs 36 provide an upward force to the retractable lifting mechanism 18, the amount of force needed from the actuator 28 to begin deployment is reduced. As the retractable lifting mechanism 18 is forced away from the base by the actuator 28, the compression springs 36 continue to supply upward biasing force on the retractable lifting mechanism 18 until the compression springs 36 return to their initial, resting length at an intermediate point in the deployment process. At the point in which the compression springs 36 reach their initial, resting length, the actuator 28 has a sufficient mechanical advantage relative to the retractable lifting mechanism 18 so that the piston 30 can continue pushing the retractable lifting mechanism 18 and platform 20 away from the base 12 independent and without the compression springs 36 or the secondary lifting system 34A. Accordingly, in some examples, the compression springs 36 provide a biasing force to the retractable lifting mechanism 18 over less than fifty percent of a stroke length of the piston 30 as the piston 30 transitions from the stowed position to the deployed position. Still, by aiding in the initial deployment process, the compression springs 36 significantly reduce the force requirements of the actuator 28, allowing a smaller and less expensive actuator 28 to be used in the AWP 10.

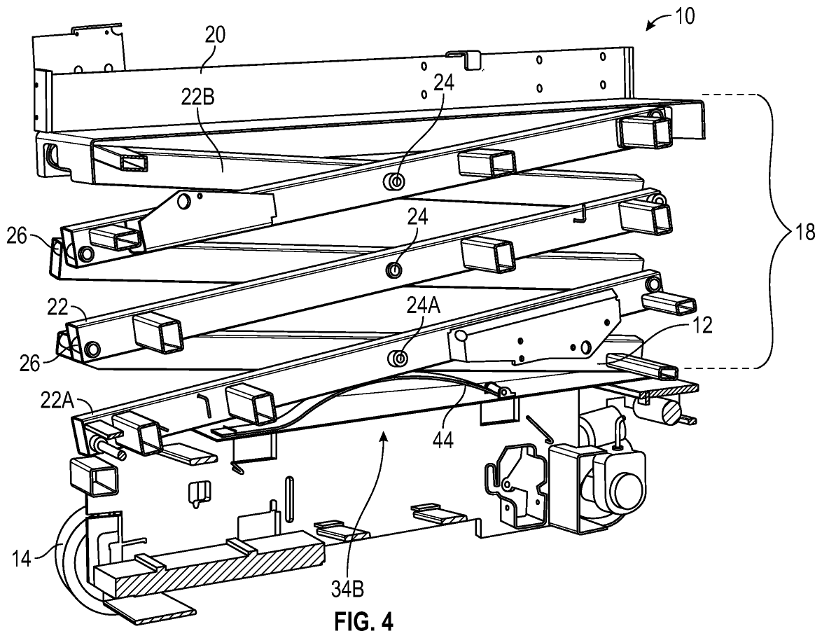

Various alternative secondary lifting systems 34B, 34C, 34D can be incorporated into the AWP 10 to aid in the initial deployment process of the actuator 28, retractable lifting mechanism 18, and platform 20. As depicted in FIG. 4, a leaf spring 44 can be included within the secondary lifting system 34B. The leaf spring 44 can be mounted to the base 12 on each end and configured to extend convexly and upwardly away from the base 12. The leaf spring 44 can bow inwardly when the lowermost foldable support members 22A (and retractable lifting mechanism 18, more generally) approach and reach the fully-stowed position. The biasing force created by the flexing of the leaf spring 44 can then be transferred to the lowermost foldable support members 22A upon deployment of the actuator 28 from the fully-stowed position. Like the compression springs 36, the biasing force produced by the leaf spring 44 is variable, and increases as the retractable lifting mechanism 18 approaches the fully-stowed position. The biasing force of the leaf spring 44 is directed approximately vertically and perpendicularly away from the base 12. The leaf spring 44 can return to its resting shape and position at an intermediate point in the deployment process, so that the actuator 28 and leaf spring 44 operate in unison during an initial portion of the deployment process until the leaf spring reaches its resting shape, at which point the actuator 28 provides the sole lifting force to the retractable lifting mechanism 18 to raise the platform 20 to its fully-deployed position.

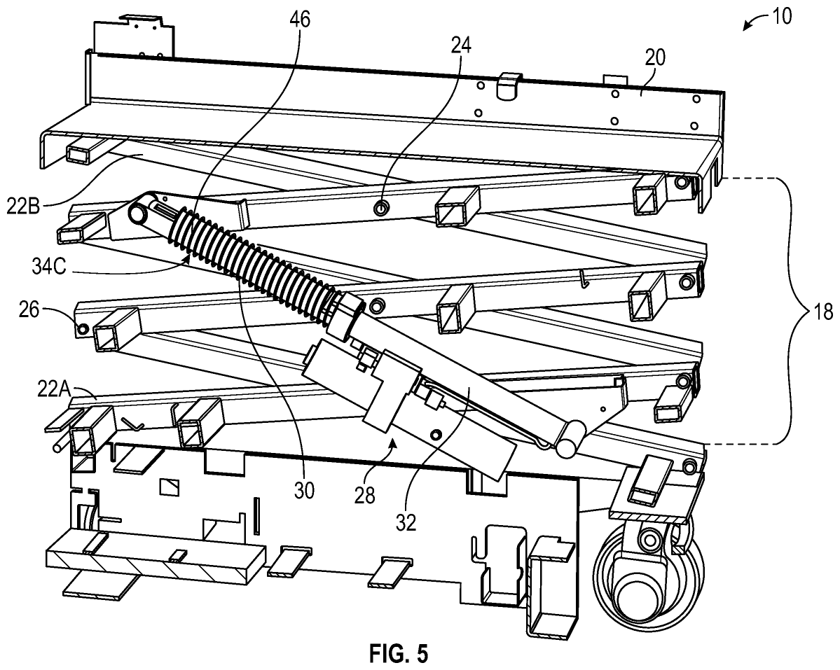

As illustrated in FIG. 5, the secondary lifting system 34C can include a compression spring 46 positioned in series with the actuator 28. The compression spring 46 can be received around the piston 30 and configured to act on the retractable lifting mechanism 18 when the piston 30 is positioned within the housing 32 in the fully-retracted position. The compression spring 46 can be coupled to the actuator housing 32 on one end, and is selectively engageable by the retractable lifting mechanism 18 on an opposite end. The compression spring 46 is configured to selectively provide a biasing force to the retractable lifting mechanism 18 in a direction parallel to an actuating force produced by the piston 30. The biasing force produced by the compression spring 46 can be collinear (i.e., coaxial) with the actuating force produced by the piston 30, for example, to supply lifting force that can be used in conjunction with the actuator 28 during the initial portion of the deployment process. During an intermediate portion of the deployment process, the piston 30 protrudes from the housing 32 to a length equal to a resting length of the compression spring 46. As the piston 30 extends further out from the housing 32, the compression spring 46 becomes disengaged from the retractable lifting mechanism 18, and the actuator 28 completes the remaining portion of the deployment process independent of the secondary lifting system 34C.

In some examples, the secondary lifting system 34D is arranged to oppose rotational motion of the foldable support members 22 relative to one another about the pivot pins 24, 26. For example, torsion springs 48 can be positioned about each outer pivot pin 26. The torsion springs 48 engage adjacent foldable support members 22 and resist inward motion that corresponds with the retractable lifting mechanism 18 approaching or otherwise transitioning toward the stowed position. The torsion springs 48 store energy when the foldable support members 22 rotate inward during retraction of the piston 30 into the housing 32 that can be used, subsequently, to deploy the retractable lifting mechanism 18. Like each of the secondary lifting systems 34A, 34B, 34C, the torsion springs 48 can be configured to provide biasing forces to the retractable lifting mechanism 18 over only an initial portion of the deployment process. Energy stored within the torsions springs 48 can be transferred to the retractable lifting mechanism 18 over an initial portion of the deployment process, until the torsion springs 48 return to their initial, resting position. Once the torsion springs 48 are at rest, the torsion springs 48 no longer bias the retractable lifting mechanism 18 and platform 20 upward, away from the base. The actuator 28 alone provides the lifting force necessary to accomplish the remainder of the deployment process. However, because the early portions of the deployment require the most lifting force, the size of the actuator 28 used on the AWP 10 can be reduced.

Various modifications can be made to the secondary lifting system 34A, 34B, 34C, 34D as well, including the use of several different types of spring or biasing elements on the same AWP 10. For example, compression springs 36 can be combined with torsion springs 48 to passively store energy to use in a subsequent deployment process. The compression spring 46 and torsion springs 48 can be incorporated into a single embodiment of the AWP 10 as well. Using several types of biasing or spring elements within a single AWP can reduce the size and material requirements of each energy-storing element, which can further reduce expenses in producing the AWP 10. The spring constants and lengths of the various springs discussed herein can be chosen so that the springs avoid plastic deformation when the retractable lifting mechanism 18 is in the stowed position, such that the springs can be used multiple times. The terms biasing element and spring element used throughout the specification are intended to refer to and include any resilient energy storing element that can both store and release mechanical energy, including each of the compression springs 36, 46, leaf springs 44, and torsion springs 48 described herein. The use of the term AWP is intended to encompass and include MEWPs.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the AWP as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. An aerial work platform, comprising:
a base;
a retractable lifting mechanism having a first end rotatably coupled to the base;
a platform coupled to and supported by a second end of the retractable lifting mechanism;
an actuator rotatably coupled to the retractable lifting mechanism, the actuator having a piston received within a housing and movable between a stowed position extending outward from the housing a first distance and a deployed position extending outward from the housing a second distance greater than the first distance, the piston engaging and forcing the retractable lifting mechanism away from the base to lift the platform away from the base in the deployed position; and
a spring biasing the retractable lifting mechanism away from the base and providing a variable biasing force to the retractable lifting mechanism that increases as the piston approaches the stowed position.

2. The aerial work platform of claim 1, wherein the spring is mounted to the base and the variable biasing force is provided in a direction perpendicular to a plane defined by the base.

3. The aerial work platform of claim 2, wherein the spring is at least one compression spring positioned between the base and a lowermost support member of the retractable lifting mechanism.

4. The aerial work platform of claim 2, wherein the spring is a leaf spring positioned between the base and a lowermost support member of the retractable lifting mechanism.

5. The aerial work platform of claim 1, wherein the spring provides the variable biasing force in a direction parallel to a force supplied by the piston.

6. The aerial work platform of claim 5, wherein the spring is a compression spring received around and coupled to the actuator.

7. The aerial work platform of claim 5, wherein the spring is positioned in series with the piston.

8. The aerial work platform of claim 1, wherein the retractable lifting mechanism is a scissor lift structure comprising a series of linked, foldable support members rotatably coupled to one another using a plurality of pivot pins, and the spring is a torsion spring positioned around at least one of the plurality of pivot pins to bias two adjacent foldable support members outwardly away from one another around the at least one pivot pin.

9. The aerial work platform of claim 8, wherein each of the plurality of pivot pins coupling the linked, foldable support members together receive a torsion spring that biases foldable support members coupled to the pivot pins away from one another.

10. The aerial work platform of claim 1, wherein the variable biasing force is less than a combined gravitational force acting on the retractable lifting mechanism and the platform, such that the retractable lifting mechanism rests on the base when the actuator is in the stowed position.

11. The aerial work platform of claim 10, wherein the variable biasing force is less than 20 percent of the combined gravitational force acting on the retractable lifting mechanism and the platform.

12. The aerial work platform of claim 1, wherein the variable biasing force reduces to zero before the piston reaches the deployed position.

13. The aerial work platform of claim 12, wherein the variable biasing force reaches a maximum when the piston reaches the stowed position.

14. The aerial work platform of claim 12, wherein the spring provides a biasing force to the retractable lifting mechanism over less than fifty percent of a stroke length of the piston as the piston transitions from the stowed position to the deployed position.

15. A scissor lift, comprising:
a base;
a retractable lifting mechanism formed of a plurality of foldable support members rotatably coupled to one another about pins, wherein a lowermost group of the plurality of foldable support members is rotatably coupled to the base;
a platform coupled to and supported by an uppermost group of the plurality of foldable support members of the retractable lifting mechanism;
an actuator pivotably coupled to at least one of the plurality of foldable support members, the actuator having a piston movable between a stowed position and an extended, deployed position, the piston engaging and forcing the plurality of foldable support members away from the base to lift the platform away from the base in the deployed position; and
a passive spring biasing the retractable lifting mechanism away from the base when the actuator is in the stowed position more than when the actuator is in the deployed position.

16. The scissor lift of claim 15, wherein the passive spring does not bias the retractable lifting mechanism away from the base when the actuator is in the deployed position.

17. The scissor lift of claim 15, wherein the passive spring is a spring received around and positioned in series with the actuator.

18. The scissor lift of claim 15, wherein the passive spring is a torsion spring received about a pin coupling two foldable support members of the retractable lifting mechanism together.

19. The scissor lift of claim 18, wherein torsion springs are received around at least two different pins coupling foldable support members of the retractable lifting mechanism together.

20. A scissor structure, comprising:
a base;
a plurality of foldable support members rotatably coupled to one another about pins, a lowermost group of the plurality of foldable support members rotatably coupled to the base;
a platform coupled to and supported by an uppermost group of the plurality of foldable support members;
an actuator pivotally coupled to at least one of the plurality of foldable support members, the actuator having a piston movable between a stowed position and an extended, deployed position, the piston engaging and forcing the plurality of foldable support members away from the base to lift the platform away from the base in the deployed position; and
a spring independent from the actuator and providing a biasing force on the plurality of foldable support members to push the plurality of foldable support members away from the base, the biasing force reaching a maximum when the actuator is in the stowed position and reducing to zero before the actuator reaches the deployed position.
